(19) United States
(12) Patent Application Publication
(10) Pub. No.: US 2012/0246723 A1
(43) Pub. Date: Sep. 27, 2012

(54) WINDOWS KERNEL ALTERATION SEARCHING METHOD

(76) Inventor: Jae Hong Lee, Guro-gu (KR)

(21) Appl. No.: 13/498,113

(22) PCT Filed: Aug. 12, 2010
(86) PCT No.: PCT/KR2010/005297

§ 371 Date: Jun. 8, 2012

(30) Foreign Application Priority Data
Sep. 24, 2009 (KR) 10-2009-0090370

(51) Int. Cl. G06F 21/00

(52) U.S. Cl. 726/22

(57) ABSTRACT

The present invention relates to a method of detecting the alteration of the driver of a windows kernel and a system using system module information that is the unalterable information of the windows kernel.

The method of detecting the alteration of a windows kernel according to the present invention includes a first step of reading, by an alteration detection driver, information about a name and start and end addresses of a detection target driver from system module information; a second step of extracting a function that is used by a driver object of the detection target driver using the name of the detection target driver; and a third step of determining that the detection target driver has not been altered if an address of the function is a value between the start address and the end address, and determining that the detection target driver has been altered if the address of the function is not a value between the start address and the end address.

### TECHNICAL FIELD

The present invention relates to a method of detecting the alteration of a windows kernel and, more particularly, to a method of detecting the alteration of the driver of a windows kernel and a system using system module information that is the unalterable information of the windows kernel.

### BACKGROUND ART

In general, many alterations of executable image code in memory occur in the form of hooking. In the case of some hacking tools, alterations are made by randomly altering specific code so as to generate an operation different from the original operation of an executable image.

Such alterations modify the operations that will actually be performed by the executable images, thereby causing many security problems. For example, a malicious program forms a Rootkit, which keeps the malicious program hidden from detection, by hooking a specific executable image, thereby generating the continuous erroneous operation of the executable image.

Alterations that are representative of kernel alterations in a windows system include driver alterations and system alterations. The above-described malicious programs do not only make alterations, but security programs carry out a variety of security functionality using also kernel alterations.

For example, keyboard security programs that are being provided in Korea include a variety of products, such as INCA Internet's nProtect KeyCrypt, SoftCamp's Secure KeyStroke, AhnLab's AhnLab online Security MyKeyDefense, Kings Information & Network's K-Defense, etc. Most of these keyboard security programs perform keyboard security functionality by altering the kernel.

That is, the keyboard security programs alter the windows kernel, hook keyboard input data, and make keyboard input data follow procedures set by them, rather a normal windows processing procedure. In doing so, keyboard input data is prevented from following the normal windows processing procedure even when a keylogger has been installed on a client computer, so that the keylogger cannot read or intercept keyboard input data.

Today, since a plurality of websites provide a variety of keyboard security programs to user clients over the Internet, at least two or more keyboard security programs have been installed in most client systems. When a plurality of keyboard security programs have been installed in a single client system, all keyboard security programs alter the windows kernel and therefore collisions occur between the keyboard security programs, so that they no longer guarantee the stability of an Operation System (OS).

In fact, a keyboard security program may run only when a keylogger has been installed on a client system. That is, if a keyboard security program runs only when a keylogger has altered a keyboard processing-related kernel, the above-described collisions between keyboard security programs will not occur. However, since the conventional keyboard security programs cannot detect the alteration of the kernel by a keylogger, they should run whenever the users client system accesses specific websites, with the result that there arises the problem of the collisions between keyboard security programs inevitably occurring.

### DISCLOSURE

### Technical Problem

Accordingly, the present invention has been made keeping in mind the above problems occurring in the prior art, and an object of the present invention is to provide a method of detecting the alteration of a kernel by a malicious program and notifying the user of a threat to security.

### Technical Solution

In order to accomplish the above object, the present invention provides a method of detecting the alteration of a windows kernel, including:

a first step of reading, by an alteration detection driver, information about a name and start and end addresses of a detection target driver from system module information;

a second step of extracting a function that is used by a driver object of the detection target driver using the name of the detection target driver; and

a third step of determining that the detection target driver has not been altered if an address of the function is a value between the start address and the end address, and determining that the detection target driver has been altered if the address of the function is not a value between the start address and the end address.

### Advantageous Effects

The above-described present invention has the effects of notifying a user of a threat to security and enabling the user to deal with it because the present invention is capable of detecting whether the driver of a kernel and a system have been altered using the system module information of the kernel.

### DESCRIPTION OF DRAWINGS

FIG. 1 is a diagram illustrating a typical windows kernel memory structure;

FIG. 2 is a diagram illustrating a case where a malicious driver loaded in windows kernel memory altered the driver object function table of a driver object space;

FIG. 3 is a diagram illustrating a state in which an alteration detection driver has been loaded in the windows kernel memory of FIG. 2; and

FIG. 4 is a flowchart illustrating a method of detecting the alteration of a windows kernel using the alteration detection driver according to the embodiment of the present invention.

### MODE FOR INVENTION

A method of detecting the alteration of a kernel according to an embodiment of the present invention will be described in detail with reference to the accompanying drawings.

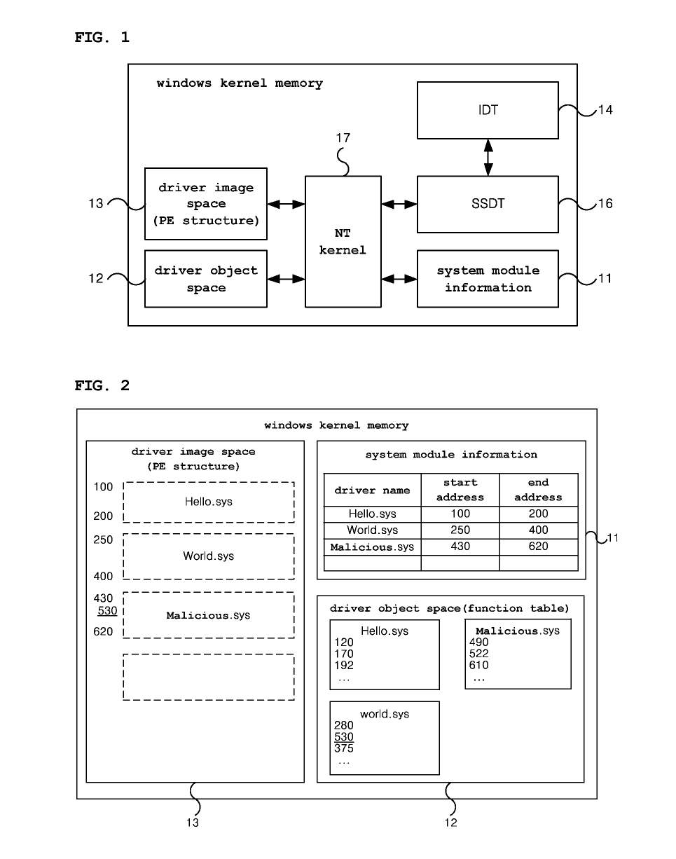

FIG. 1 is a diagram illustrating a typical windows kernel memory structure.

Information about all drivers running on a windows OS is stored in windows kernel memory in a variety of forms. The information stored in the windows kernel memory includes system module information 11, a driver object space 12, a driver image space (Portable Executable (PE) structure) 13, an Interrupt Descriptor Table (IDT) 14, and a System Service Descriptor Table (SSDT) 16.

An NT kernel 17 is responsible for the management of a variety of data structures generally used in windows kernel memory, the loading of drivers, the input and output of devices, and the provision of system calls.

A list of currently loaded drivers is stored in the system module information 11. That is, the driver name of each driver image and information about the start and end addresses of a place where the driver image is loaded are stored.

The function table of each driver object is stored in the driver object space 12. Address values that are referred to by functions that constitute the driver object of a driver should be address values within the driver image space (PE structure) 13 of the corresponding driver.

An image of a driver (The state in which a driver file has been loaded in memory is referred to as an image) whose driver file has been currently loaded in memory is stored in the driver image space (PE structure) 13. The driver file and the driver image are configured in the form of PE structures. A PE structure stores information, including the location of the machine language of an executable file, the locations of import and export tables, the type of platform on which the corresponding file can run, and the location of a first start code when an OS executes the file.

The IDT 14 stores the address of an interrupt handler. The SSDT 16 stores the address of a routine that should be called for each function when a system call is generated.

Malicious programs including keyloggers attempt cracking by altering the driver object space 12, driver image space (PE structure) 13, IDT 14, SSDT 16 and hook callback of the memory. However, these malicious programs cannot alter the system module information 11 of the kernel at all. If the system module information 11 is altered, the OS operates erroneously and the system is rebooted.

FIG. 2 is a diagram illustrating a case where a malicious driver loaded in the windows kernel memory altered the driver object function table of the driver object space.

When a malicious program is loaded in the memory, the executable driver image (malicious.sys) of the corresponding malicious program is also loaded in a driver image space (PE structure) 13. Furthermore, the start and end addresses of a place where the name and executable driver image of the corresponding malicious driver are stored, are stored in a system module information 11. Furthermore, a table of functions that are used by the corresponding malicious driver object is stored in a driver object space 12, and corresponding information is stored in an IDT (not shown), an SSDT (not shown) and a driver image space (PE structure) 13 themselves.

For example, when three drivers (hello.sys, world.sys, and malicious.sys) are loaded in this computer system, each driver image is loaded and stored in the driver image space (PE structure) 13, and a list of driver images loaded in the memory is stored in the system module information 11. The driver name and start and end addresses of each driver image are stored.

Meanwhile, functions required for the drivers to actually run are arranged and stored in the necessary driver object space 12. When the malicious driver alters an address value, which is referred to by a function of the world.sys driver object, into an address value within a malicious driver image, hooking occurs. For example, when an address value that is referred to by the keyboard value processing function of the world.sys driver object is altered into an address value (for example, 530) within the malicious driver image, the world.sys driver outputs keyboard values to the malicious driver, and the malicious driver can intercept the keyboard values.

The present invention proposes a method of detecting whether a malicious driver alters a kernel as described above.

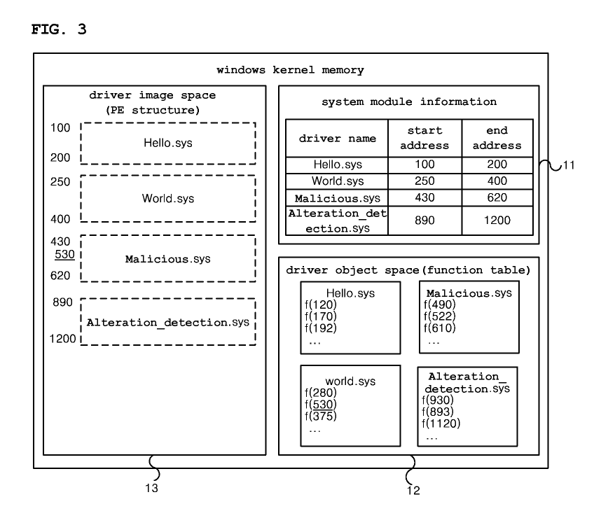

The method of detecting the alteration of a kernel according to the present invention is provided in the form of an alteration detection program, and is run on a user computer. FIG. 3 is a diagram illustrating a state in which an alteration detection driver has been loaded on in the windows kernel memory of FIG. 2.

When a kernel alteration detection program is executed, an alteration detection driver image is loaded in the driver image space (PE structure) 13, and the name of the alteration detection driver and the start and end addresses of the alteration detection driver in the image space are stored in the system module information 11. Furthermore, a function table that is used by the alteration detection driver is stored in the driver object space 12.

The present invention is implemented by the alteration detection driver loaded in the windows kernel memory as described above, and detects whether the kernel driver has been altered.

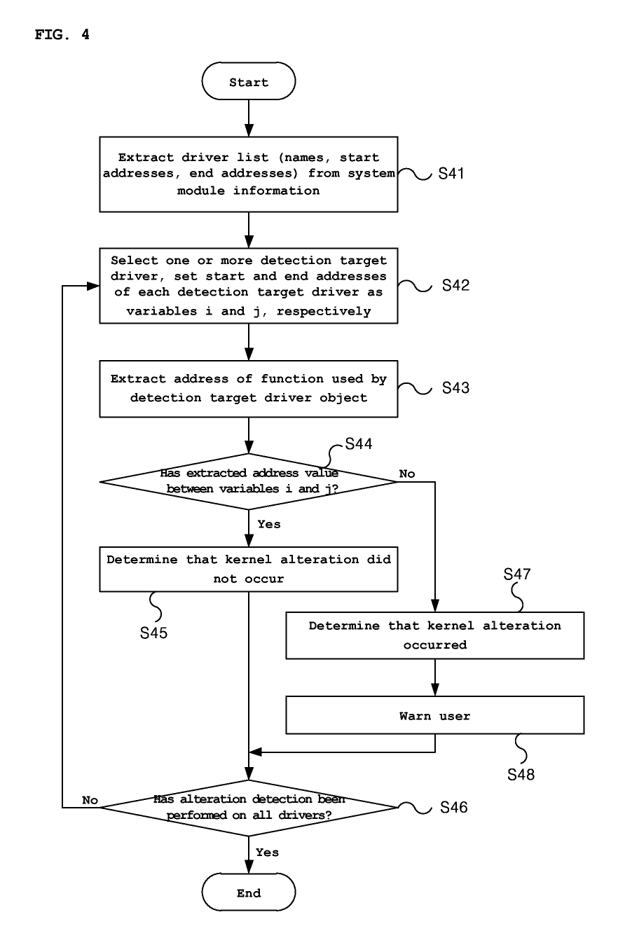

FIG. 4 is a flowchart illustrating a method of detecting the alteration of a windows kernel using the alteration detection driver according to the embodiment of the present invention.

First, the alteration detection driver reads a driver list from the system module information and extracts information about the name and start and end addresses of a driver that is currently running on the system at step S41.

The alteration detection driver selects a detection target driver from the driver list read from the system module information, and sets the start address of the detection target driver as variable i and the end address of the detection target driver as variable j at step S42.

Thereafter, the alteration detection driver extracts the argument of a function that is used by the detection target driver object at step S43. In this case, using an ObReferenceObject function, an ObReferenceObjectByName function, and an ObReferenceObjectByHandlefunction, ObReferenceObjectByPointer function, the alteration detection driver can find a location at which the function table of the driver object of the detection target driver is stored, and can extract the address of each function from the function table of the detection target driver object.

The alteration detection driver determines whether the address extracted at step S43 is a value between the variable i and the variable j at step S44, determines that alteration has not occurred in the corresponding detection target driver at step S45 if the extracted address is a value between the variable i and the variable j, and determines whether alteration detection has been performed on the entire driver list at step S46.

If there is a driver on which alteration detection will be performed, the process returns to step S42, where the part of the process starting with the selection of a detection target driver starts to be repeated. In contrast, if there is no driver on which alteration detection will be performed, the process ends.

Meanwhile, if the address extracted at step S43 is not a value between the variable i and the variable j at determination step S44, the alteration detection driver determines that the corresponding detection target driver has been altered at step S47, notifies a user of the alteration of the corresponding executable program at step S48, and proceeds to step S46.

The present invention can detect not only the alteration of the above-described driver object but also the alteration of the IDT, the driver image space (PE structure), the SSDT, and the hook callback.

In the case of the IDT 14, the interrupt number of a detection target device is obtained using a HalGetInterruptVector function, and the IDT of the corresponding detection target device is obtained using an asm sidt command. Meanwhile, whether the IDT has been altered can be checked by examining the address of the IDT and a service routine address.

In the case of the driver image space (PE structure) 13, the detection target driver is opened, the starting part of the detection target driver is set as an IMAGE_DOS_HEADER structure, the location of an IMAGE_OPTIONAL_HEADER structure is obtained from the IMAGE_DOS_HEADER structure, and the location of the IMAGE_IMPORT_DESCRIPTOR structure is obtained from an IMAGE_OPTIONAL_HEADER structure. Meanwhile, the address of each function is checked for alteration by examining a function table included in the IMAGE_IMPORT_DESCRIPTOR structure.

In the case of the SSDT, alteration is detected by examining a function address included in the KeServiceDescriptorTable.

In the case of the hook callback, the driver object of the detection target driver is obtained using an ObReferenceObject function, an ObReferenceObjectByName function, an ObReferenceObjectByHandle function, and an ObReferenceObjectByPointer function, and a device object is obtained using the obtained driver object. Meanwhile, alteration is detected by examining a hook callback address included in the device object.

Although the technical spirit of the present invention has been described in conjunction with the accompanying drawings, this is intended to illustrate the preferred embodiments of the present invention, and is not intended to limit the present invention. Furthermore, it will be apparent to those having ordinary knowledge in the field of art that a variety of modifications and variations are possible within the range which does not depart from the scope of the technical spirit.

1. A method of detecting alteration of a windows kernel, comprising:
a first step of reading, by an alteration detection driver, information about a name and start and end addresses of a detection target driver from system module information;
a second step of extracting a function that is used by a driver object of the detection target driver using the name of the detection target driver; and
a third step of determining that the detection target driver has not been altered if an address of the function is a value between the start address and the end address, and determining that the detection target driver has been altered if the address of the function is not a value between the start address and the end address.

2. The method set forth in claim 1, wherein the second step uses one of an ObReferenceObject function, an ObReferenceObjectByName function, an ObReferenceObjectByHandle function, and an ObReferenceObjectByPointer function.

3. The method set forth in claim 1, wherein the alteration detection driver further detects whether a driver object, IDT, PE structure, SSDT, and/or hook callback of the detection target driver have/has been altered.

4. The method set forth in claim 1, wherein the alteration detection driver determines that the detection target driver has been altered and then notifies a user of the alteration of an executable program of the detection target driver.
